(19) United States
(12) Patent Application Publication
(10) Pub. No.: US 2013/0206562 A1
(43) Pub. Date: Aug. 15, 2013

(54) KEYBOARD WITH WATER-DRAINING FUNCTION

(71) Applicants: Chih-Wen Su, Taipei (TW); Chen-Wei Chan, Taipei (TW)

(72) Inventors: Chih-Wen Su, Taipei (TW); Chen-Wei Chan, Taipei (TW)

(73) Assignee: Primax Electronics Ltd., Taipei (TW)

(21) Appl. No.: 13/437,483

(22) Filed: Apr. 2, 2012

(30) Foreign Application Priority Data
Feb. 10, 2012 (TW) 101104326

(51) Int. Cl. H01H 13/76; H01H 1/10; H01H 9/04

(52) U.S. Cl. 200/5 A; 200/302.1

(57) ABSTRACT

A keyboard with a water-draining function is provided. The keyboard includes a base, an upper cover, and a flexible plate. The base has at least one drainage hole. The upper cover has at least one upper cover opening corresponding to the at least one drainage hole. The flexible plate has at least one flexible plate opening corresponding to the at least one drainage hole. The flexible plate is arranged between the upper cover and the base. The flexible plate is contacted with the upper cover and the base, so that the at least one drainage hole is connected with the corresponding upper cover opening. The liquid splashed on the keyboard may flow through the upper cover opening, the flexible plate opening and the drainage hole, and then the liquid is exhausted out of the keyboard.

### FIELD OF THE INVENTION

The present invention relates to a keyboard, and more particularly to a keyboard for a desktop computer.

### BACKGROUND OF THE INVENTION

A keyboard is a widely used peripheral device of a computer. Generally, the keyboard is in communication with a computer host. Via the keyboard, a character signal or a numeric signal may be inputted into the computer host. According to the character signal or the numeric signal, the computer host executes the function of a corresponding command.

Hereinafter, the configurations of a conventional keyboard will be illustrated with reference to FIGS. 1 and 2. FIG. 1 is a schematic perspective view illustrating the outward appearance of a conventional keyboard. FIG. 2 is a schematic partial exploded view illustrating the conventional keyboard. As shown in FIGS. 1 and 2, the conventional keyboard 1 comprises a base 10, an upper cover 11, plural keycaps 12, a flexible plate 13, a membrane switch circuit member 14, and a main circuit board 15. From top to bottom, the keycaps 12, the upper cover 11, the flexible plate 13, the membrane switch circuit member 14 (and the main circuit board 15) and the base 10 of the conventional keyboard 1 are sequentially shown. The main circuit board 15 is located beside the membrane switch circuit member 14. The membrane switch circuit member 14 is disposed on the base 10. Moreover, the membrane switch circuit member 14 has plural key intersections 141. The main circuit board 15 is also disposed on the base 10, and connected with the membrane switch circuit member 14. The flexible plate 13 is disposed over the membrane switch circuit member 14. Moreover, plural elastic elements 131 are disposed on the flexible plate 13. The plural elastic elements 131 are aligned with respective key intersections 141 of the membrane switch circuit member 14. The upper cover 11 is disposed over the flexible plate 13. The plural keycaps 12 are disposed on the upper cover 11 and exposed outside the upper cover 11. The plural keycaps 12 are movable upwardly or downwardly relative to the upper cover 11. These keycaps 12 are aligned with respective elastic elements 131. After the above components are combined together, the outward appearance of the resulting structure of the conventional keyboard 1 is shown in FIG. 1.

Please refer to FIG. 2 again. The main circuit board 15 is connected with a power source (not shown) for acquiring electric power and transmitting the electric power to the membrane switch circuit member 14. Consequently, when one of the plural key intersections 141 of the membrane switch circuit member 14 is triggered, the membrane switch circuit member 14 issues a corresponding key signal. Generally, a keycap 12, a fixing structure (not shown) of the upper cover 11 for fixing the keycap 12 and a corresponding elastic element 131 are collectively defined as a key. When any keycap 12 is depressed by the user and the keycap 12 is moved downwardly relative to the upper cover 11, the keycap 12 is moved downwardly to compress the underlying elastic element 131. As the elastic element 131 is subject to deformation, the elastic element 131 is contacted with the underlying membrane switch circuit member 14 to trigger the corresponding key intersection 141 to output a corresponding key signal. Then, the key signal is transmitted to the main circuit board 15. According to the key signal, the main circuit board 15 may recognize which key has been triggered. Moreover, according to the key signal, the computer host (not shown) in communication with the conventional keyboard 1 will execute the function of a corresponding command.

Whereas, when the depressing force exerted on the keycap 12 is eliminated, an elastic force provided by the compressed elastic element 131 is acted on the keycap 12. Due to the elastic force, the elastic element 131 is restored to its original shape and no longer contacted with the membrane switch circuit member 14. In addition, due to the elastic force, the keycap 12 is moved upwardly relative to the upper cover 11, and returned to the original position where the keycap has not been depressed. The operations of the conventional keyboard 1 have been described as above.

Generally, during the process of operating the conventional keyboard 1, the conventional keyboard 1 is placed on a working surface (e.g. a desk surface). The user may sometimes place beverages or tea on the desk surface and beside the keyboard 1. That is, the user may drink the beverages or tea while operating the keyboard 1. However, if the beverages or tea is inadvertently spilled by the user, the beverages or tea may be splashed into the internal portion of the conventional keyboard 1 through the seams between the upper cover 11 and the keycaps 12. Once the beverages or tea flows to the conductor lines of the membrane switch circuit member 14 or the main circuit board 15, the conductor lines are possibly suffered from a short-circuited problem. Under this circumstance, the membrane switch circuit member 14 or the main circuit board 15 are damaged, and the conventional keyboard 1 fails to be normally operated.

### SUMMARY OF THE INVENTION

The present invention provides a keyboard with a water-draining function.

In accordance with an aspect of the present invention, there is provided a keyboard with a water-draining function. The keyboard includes a base, an upper cover, and a flexible plate. The base has at least one drainage hole. The at least one drainage hole runs through a top surface and a bottom surface of the base. In addition, a liquid is permitted to flow through the at least one drainage hole. The base is covered by the upper cover. The upper cover has at least one upper cover opening corresponding to the at least one drainage hole. The at least one upper cover opening is located at a bottom part of the upper cover. The liquid outside the upper cover is permitted to flow into the at least one upper cover opening. The flexible plate is arranged between the base and the upper cover. The flexible plate is connected with the base and the upper cover, so that the base is connected with the upper cover through the flexible plate. The flexible plate has at least one flexible plate opening corresponding to the at least one drainage hole. The at least one flexible plate opening runs through a top surface and a bottom surface of the flexible plate. The liquid is permitted to flow through the at least one flexible plate opening, and prevented from flowing through a region between the base and the upper cover.

In an embodiment, the flexible plate further includes at least one upper connecting ring corresponding to the at least one flexible plate opening. The at least one flexible plate opening is enclosed by the at least one upper connecting ring. The at least one upper connecting ring is disposed on the top surface of the flexible plate. When the flexible plate is contacted with the upper cover, at least one inner wall of the at least one upper connecting ring is contacted with the upper cover, so that the upper cover is connected with the flexible plate.

In an embodiment, the upper cover further includes at least one hollow post corresponding to the upper cover opening. The upper cover opening is enclosed by the at least one hollow post. Moreover, the at least one hollow post is contacted with the at least one inner wall of the at least one upper connecting ring, so that the at least one hollow post is connected with the at least one flexible plate opening of the flexible plate.

In an embodiment, the at least one upper connecting ring is a raised structure protruded from the top surface of the flexible plate. The at least one upper connecting ring is integrally formed with the flexible plate. The at least one hollow post is extended from the bottom part of the upper cover. The at least one hollow post is integrally formed with the upper cover.

In an embodiment, after the liquid outside the upper cover flows into the at least one upper cover opening, the liquid sequentially flows through the at least one hollow post, the at least one flexible plate opening and at least one drainage hole, and flows out of the base.

In an embodiment, the flexible plate further includes at least one lower connecting ring corresponding to the at least one flexible plate opening. The at least one flexible plate opening is enclosed by the at least one lower connecting ring. The at least one lower connecting ring is disposed on the bottom surface of the flexible plate. When the flexible plate is contacted with the base, at least one outer wall of the at least one lower connecting ring is contacted with the base, so that the base is connected with the flexible plate.

In an embodiment, the base further includes at least one base bulge corresponding to the at least one drainage hole. The at least one base bulge is disposed on the top surface of the base. The at least one drainage hole is enclosed by the at least one base bulge. The at least one outer wall of the at least one lower connecting ring is contacted with the at least one base bulge, so that the at least one drainage hole of the base is connected with the at least one flexible plate opening of the flexible plate.

In an embodiment, the at least one lower connecting ring is a raised structure protruded from the bottom surface of the flexible plate. The at least one lower connecting ring is integrally formed with the flexible plate. The at least one base bulge is protruded from the top surface of the base. The at least one base bulge is integrally formed with the base.

In an embodiment, the base further includes plural salient points. The plural salient points are disposed on the top surface of the base. The at least one drainage hole is enclosed by the plural salient points. The plural salient points are contacted with the bottom surface of the flexible plate, so that the at least one drainage hole of the base is connected with the at least one flexible plate opening of the flexible plate.

In an embodiment, the at least one lower connecting ring is a raised structure protruded from the bottom surface of the flexible plate. The at least one lower connecting ring is integrally formed with the flexible plate. The plural salient points are protruded from the top surface of the base. The plural salient points are integrally formed with the base.

In an embodiment, the top surface of the base and the bottom surface of the flexible plate are flat surfaces, and the top surface of the base is contacted with the bottom surface of the flexible plate, so that the at least one drainage hole of the base is connected with the at least one flexible plate opening of the flexible plate.

In an embodiment, the keyboard further includes plural keycaps, a membrane switch circuit member, a main circuit board, a battery compartment, a frame. The plural keycaps are disposed on the upper cover, movable upwardly or downwardly relative to the upper cover, and aligned with plural elastic elements of the flexible plate. When one of the plural keycaps is depressed and moved downwardly relative to the upper cover, the corresponding elastic element is pressed by the keycap. The membrane switch circuit member is arranged between the base and the flexible plate. When the membrane switch circuit member is triggered by the corresponding elastic element of the flexible plate, the membrane switch circuit member issues a corresponding key signal. The main circuit board is disposed on the base and connected with the membrane switch circuit member for receiving, recognizing and outputting the corresponding key signal. The battery compartment is disposed on the base and located beside the membrane switch circuit member for accommodating an electric power storage element. The electric power storage element is connected with the main circuit board for providing electric power to the main circuit board, so that the electric power is transmitted to the membrane switch circuit member through the main circuit board. The frame is arranged between the upper cover and the base. The membrane switch circuit member, the main circuit board and the battery compartment are enclosed by the frame, so that the membrane switch circuit member, the main circuit board and the battery compartment are not exposed outside.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional keyboard;

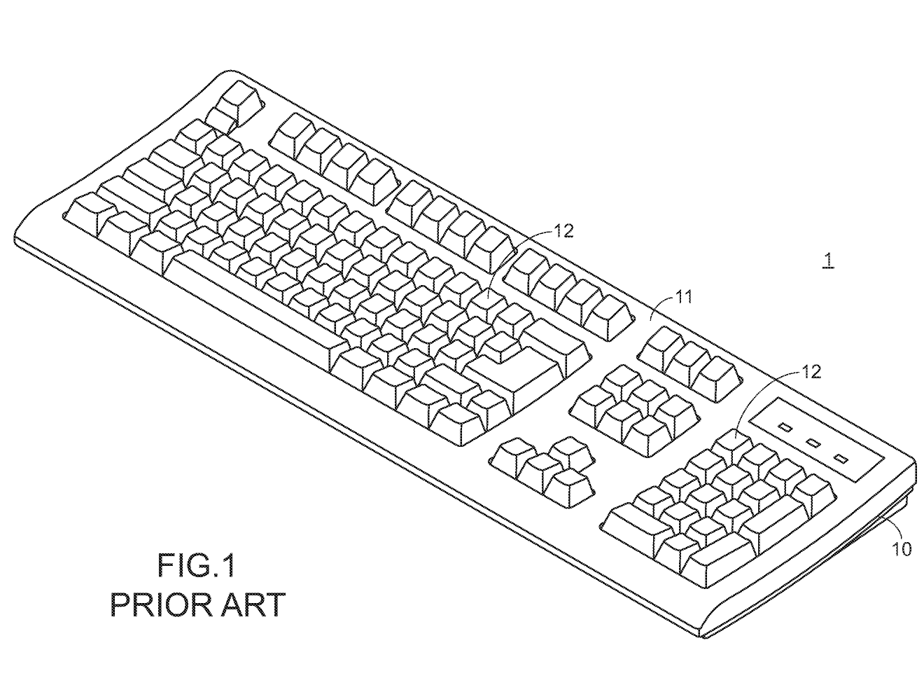

FIG. 2 is a schematic partial exploded view illustrating the conventional keyboard;

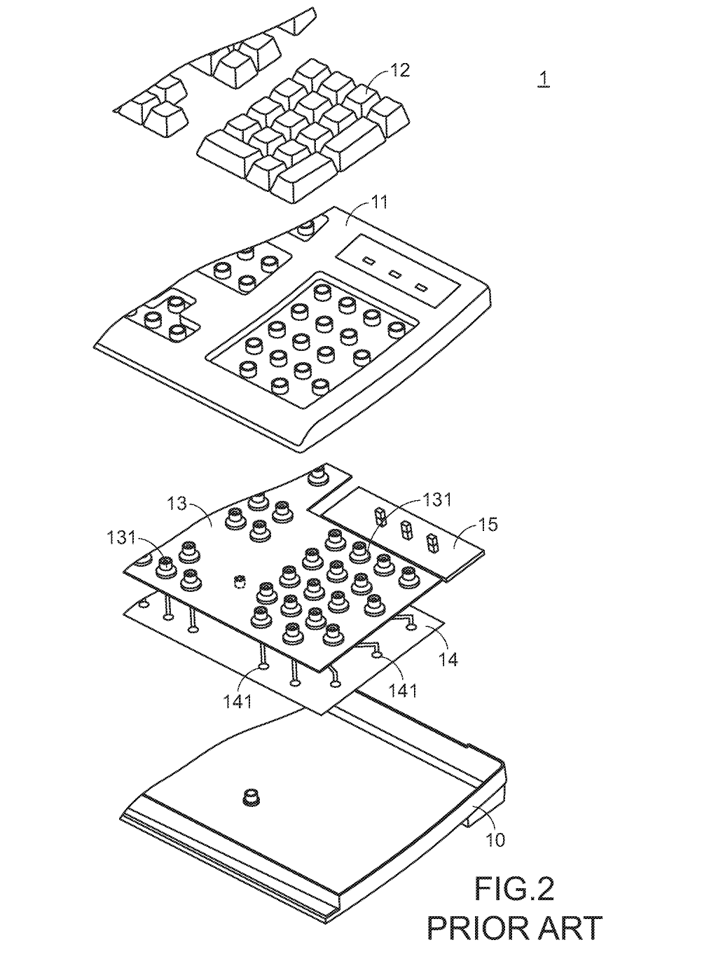

FIG. 3 is a schematic exploded view illustrating a keyboard with a water-draining function according to a first embodiment of the present invention;

FIG. 4 is a schematic exploded view illustrating the keyboard according to the first embodiment of the present invention and taken along another viewpoint;

FIG. 5 is a schematic cutaway view illustrating a keyboard with a water-draining function according to the first embodiment of the present invention;

FIG. 6 is a schematic cross-sectional and side view illustrating a keyboard with a water-draining function according to the first embodiment of the present invention;

FIG. 7 is a schematic exploded view illustrating a keyboard with a water-draining function according to a second embodiment of the present invention;

FIG. 8 is a schematic cutaway view illustrating a keyboard with a water-draining function according to the second embodiment of the present invention;

FIG. 9 is a schematic exploded view illustrating a keyboard with a water-draining function according to a third embodiment of the present invention; and

FIG. 10 is a schematic cutaway view illustrating a keyboard with a water-draining function according to the third embodiment of the present invention.

### DETAILED DESCRIPTION OF THE PREFERRED EMBODIMENT

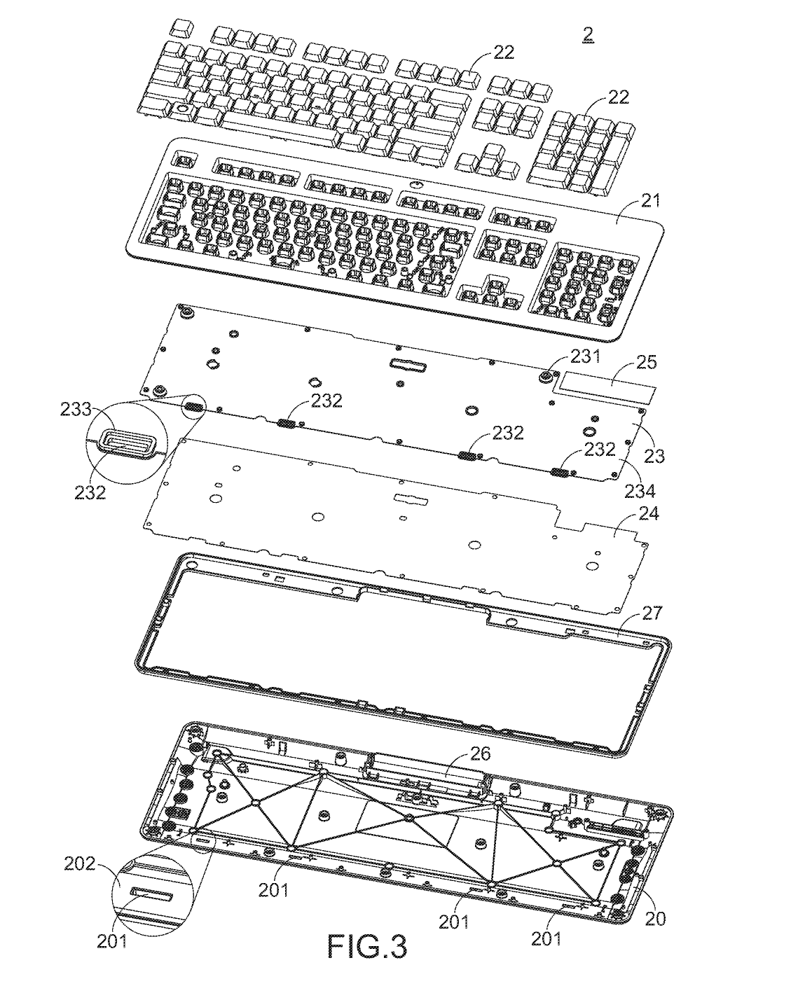

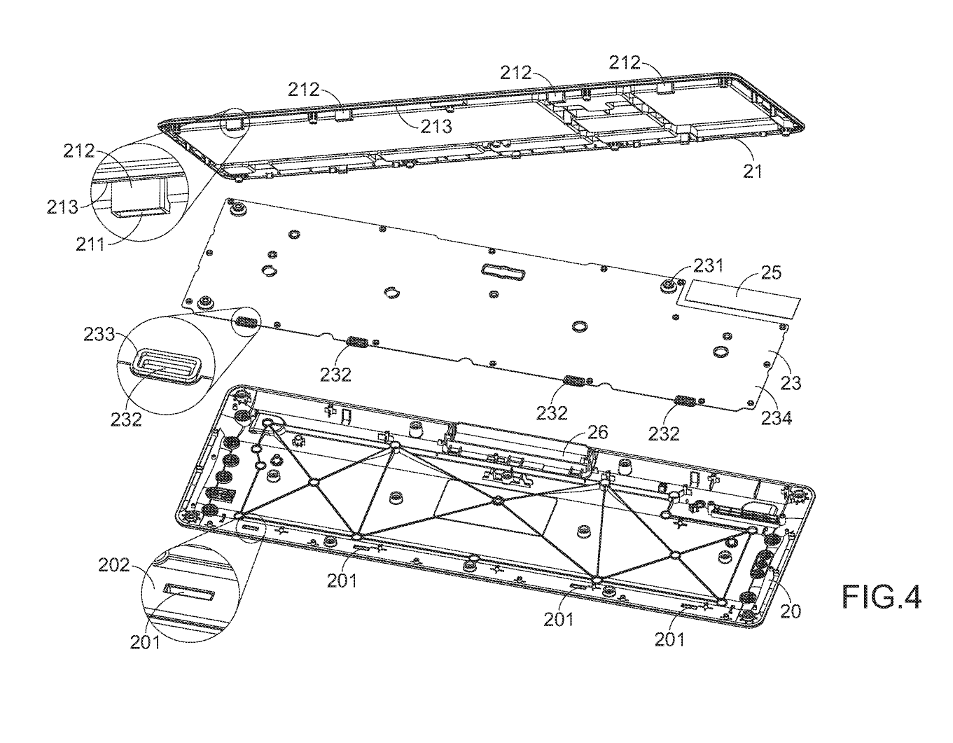

For obviating the drawbacks encountered from the prior art, the present invention provides a keyboard with a water-draining function. FIG. 3 is a schematic exploded view illustrating a keyboard with a water-draining function according to a first embodiment of the present invention. FIG. 4 is a schematic exploded view illustrating the keyboard according to the first embodiment of the present invention and taken along another viewpoint. As shown in FIGS. 3 and 4, the keyboard 2 comprises a base 20, an upper cover 21, plural keycaps 22, a flexible plate 23, a membrane switch circuit member 24, a main circuit board 25, a battery compartment 26, and a frame 27. From top to bottom, the keycaps 22, the upper cover 21, the frame 27, the flexible plate 23, the membrane switch circuit member 24 (and the main circuit board 25 or the battery compartment 26) and the base 20 of the keyboard 2 are sequentially shown. The main circuit board 25 is located beside the membrane switch circuit member 24. In this embodiment, the keyboard 2 is a keyboard for a desktop computer.

Please refer to FIGS. 3 and 4 again. The base 20 has plural drainage holes 201. The membrane switch circuit member 24 is disposed on the base 20. Moreover, the membrane switch circuit member 24 has plural key intersections (not shown). The main circuit board 25 is also disposed on the base 20, and connected with the membrane switch circuit member 24. The flexible plate 23 is disposed over the membrane switch circuit member 24. Moreover, plural elastic elements 231 are disposed on the flexible plate 23. For clarification and brevity, only one elastic element 231 is shown in the drawings. The flexible plate 23 further comprises plural flexible plate openings 232 and plural upper connecting rings 233. The plural elastic elements 231 are aligned with respective key intersections of the membrane switch circuit member 24. The plural flexible plate openings 232 are aligned with respective drainage holes 201 of the base 20. The plural upper connecting rings 233 are aligned with respective flexible plate openings 232. In this embodiment, the elastic element 231 is made of rubbery material. The upper cover 21 is disposed over the flexible plate 23. Moreover, the upper cover 21 further comprises plural upper cover openings 211 and plural hollow posts 212. The plural upper cover openings 211 and the plural hollow posts 212 are aligned with respective drainage holes 201. The plural keycaps 22 are disposed on the upper cover 21 and exposed outside the upper cover 21. The plural keycaps 22 are movable upwardly or downwardly relative to the upper cover 21. The plural keycaps 22 are aligned with respective elastic elements 231.

The battery compartment 26 is disposed on the base 20, and located beside the membrane switch circuit member 24. The battery compartment 26 is used for accommodating an electric power storage element (not shown). The electric power storage element is connected with the main circuit board 25 through metal contacts (not shown) and electric wires (not shown) so as to provide electric power to the main circuit board 25. Moreover, the electric power is transmitted to the membrane switch circuit member 24 through the main circuit board 25. In this embodiment, the electric power storage element is a battery. The frame 27 is arranged between the upper cover 21 and the base 20. The membrane switch circuit member 24, the main circuit board 25 and the battery compartment 26 are enclosed by the frame 27. Consequently, the membrane switch circuit member 24, the main circuit board 25 and the battery compartment 26 are not exposed outside.

The operations of the keyboard 2 will be illustrated as follows. When any keycap 22 is depressed by the user and the keycap 22 is moved downwardly relative to the upper cover 21, the keycap 22 is moved downwardly to compress the underlying elastic element 231. As the elastic element 231 is subject to deformation, the elastic element 231 is contacted with the underlying membrane switch circuit member 24 to trigger the corresponding key intersection to output a corresponding key signal. Then, the key signal is transmitted to the main circuit board 25. According to the key signal, a control circuit (not shown) of the main circuit board 25 may recognize which key has been triggered. In addition, the key signal is transmitted to a computer host (not shown), which is in communication with the conventional keyboard 2. According to the key signal, the computer host will execute the function of a corresponding command. Whereas, when the depressing force exerted on the keycap 22 is eliminated, an elastic force provided by the compressed elastic element 231 is acted on the keycap 22. Due to the elastic force, the elastic element 231 is restored to its original shape and no longer contacted with the membrane switch circuit member 24. In addition, due to the elastic force, the keycap 22 is moved upwardly relative to the upper cover 21, and returned to the original position where the keycap has not been depressed.

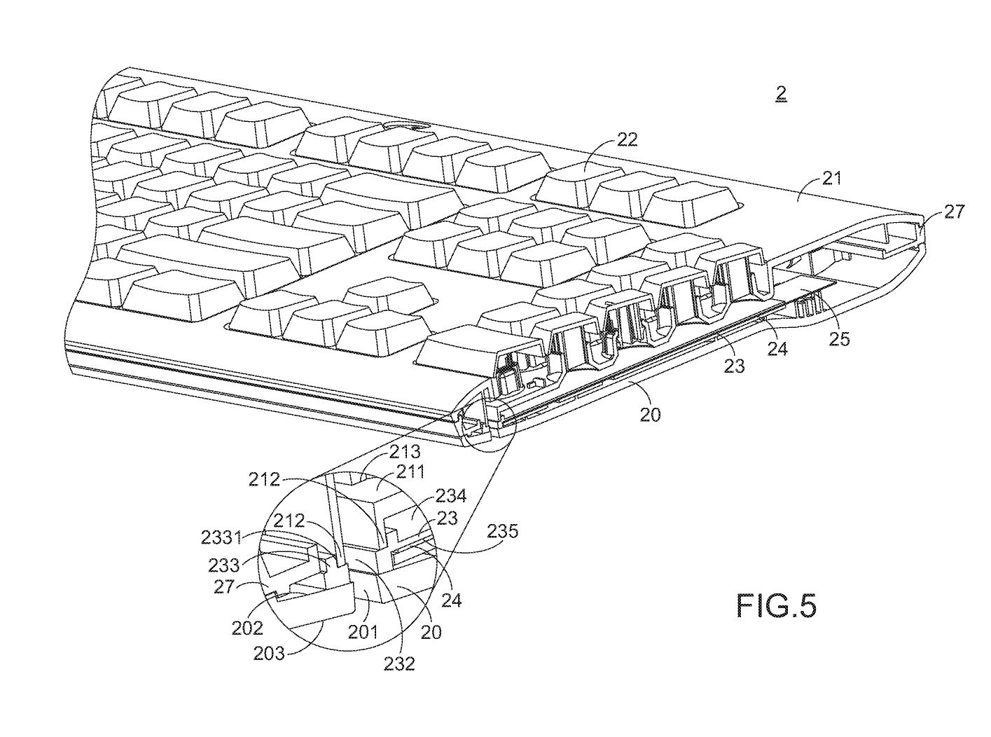

After the above components are combined together, the resulting structure of the keyboard 2 is illustrated with reference to FIG. 5. FIG. 5 is a schematic cutaway view illustrating a keyboard with a water-draining function according to the first embodiment of the present invention. The plural drainage holes 201 of the base 20 run through a top surface 202 and a bottom surface 203 of the base 20. For clarification and brevity, only one drainage hole 201 is shown in the drawings. A liquid (e.g. beverage or tea) is permitted to flow through the plural drainage holes 201. The bottom surface 203 of the base 20 may be contacted with a working surface (not shown). In this embodiment, the top surface 202 of the base 20 is a flat surface. The plural upper cover openings 211 of the upper cover 21 are located at a bottom part 213 of the upper cover 21. The liquid outside the upper cover 21 may flow into the plural upper cover openings 211. The plural upper cover openings 211 are enclosed by respective hollow posts 212. In addition, the plural hollow posts 212 are in contact with the flexible plate 23. In this embodiment, the plural hollow posts 212 are extended from the bottom part 213 of the upper cover 21. Moreover, the plural hollow posts 212 are integrally formed with the upper cover 21.

Please refer to FIG. 5 again. The flexible plate 23 is arranged between the base 20 and the upper cover 21, and contacted with the base 20 and the upper cover 21. That is, the base 20 and upper cover 21 are connected with the flexible plate 23. Moreover, the plural flexible plate openings 232 of the flexible plate 23 run though a top surface 234 and a bottom surface 235 of the flexible plate 23. For clarification and brevity, only one flexible plate opening 232 is shown in the drawings. Moreover, the liquid is permitted to flow through the plural flexible plate openings 232, but the liquid fails to flow into the region between the base 20 and the upper cover 21. Consequently, the liquid will not be contacted with the membrane switch circuit member 24, the main circuit board 25 or the battery compartment 26. The plural upper connecting rings 233 are disposed on the top surface 234 of the flexible plate 23. In addition, the flexible plate openings 232 are enclosed by respective upper connecting rings 233. In a case that the flexible plate 23 is contacted with the upper cover 21, the inner walls 2331 of the plural upper connecting rings 233 are contacted with respective hollow posts 212. That is, the upper cover 21 is connected with the flexible plate 23 through the upper connecting rings 233. In this embodiment, the plural upper connecting rings 233 are raised structures that are protruded from the top surface 234 of the flexible plate 23. In addition, the plural upper connecting rings 233 are integrally formed with the flexible plate 23. The bottom surface 235 of the flexible plate 23 is a flat surface.

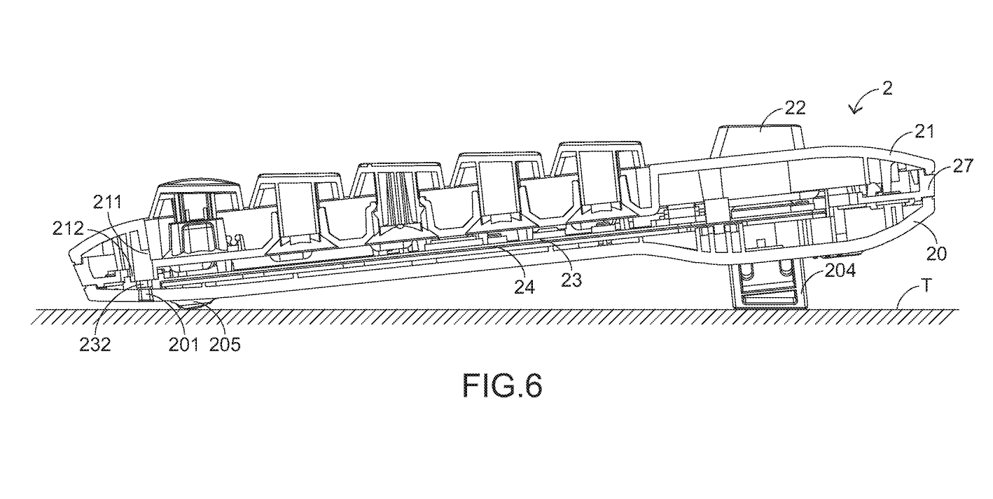

FIG. 6 is a schematic cross-sectional and side view illustrating a keyboard with a water-draining function according to the first embodiment of the present invention. Please refer to FIGS. 5 and 6. The keyboard 2 with the water-draining function is placed on a working surface T (see FIG. 6). The base 20 of the keyboard 2 further comprises at least one long base leg 204 and at least one short base leg 205. The long base leg 204 and the short base leg 205 are disposed on the bottom of the base 20. After the long base leg 204 and the short base leg 205 are contacted with the working surface T, the keyboard 2 is placed on the working surface T in an inclined status. Since the keyboard 2 is inclined, the liquid within the keyboard 2 may be guided to the upper cover openings 211 more easily. As shown in FIGS. 5 and 6, the plural upper connecting rings 233 of the flexible plate 23 are contacted with the plural hollow posts 212 of the upper cover 21, so that the plural hollow posts 212 are connected with respective flexible plate openings 232. In addition, the bottom surface 235 of the flexible plate 23 is contacted with the top surface 202 of the base 20, so that the plural flexible plate openings 232 are connected with the plural drainage holes 201. That is, the keyboard 2 has a water-draining path from the upper cover openings 211 to the drainage holes 201 through the hollow posts 212 and the flexible plate openings 232. That is, the external liquid introduced into the upper cover openings 211 of the upper cover 21 is sequentially transmitted through the hollow posts 212 and the flexible plate openings 232, and finally exhausted out of the base 20 through the drainage holes 201.

From the above discussions, since the flexible plate 23 is connected with the upper cover 21 and the base 20, the water-draining path may be defined by the upper cover 21, the flexible plate 23 and the base 20. Due to the water-draining path, the liquid is only permitted to flow through the plural hollow posts 212 and the plural flexible plate openings 232. Moreover, since the water-draining path is isolated from the membrane switch circuit member 24, the main circuit board 25 and the battery compartment 26, if the liquid flows into the keyboard 2, the short-circuited problem is eliminated.

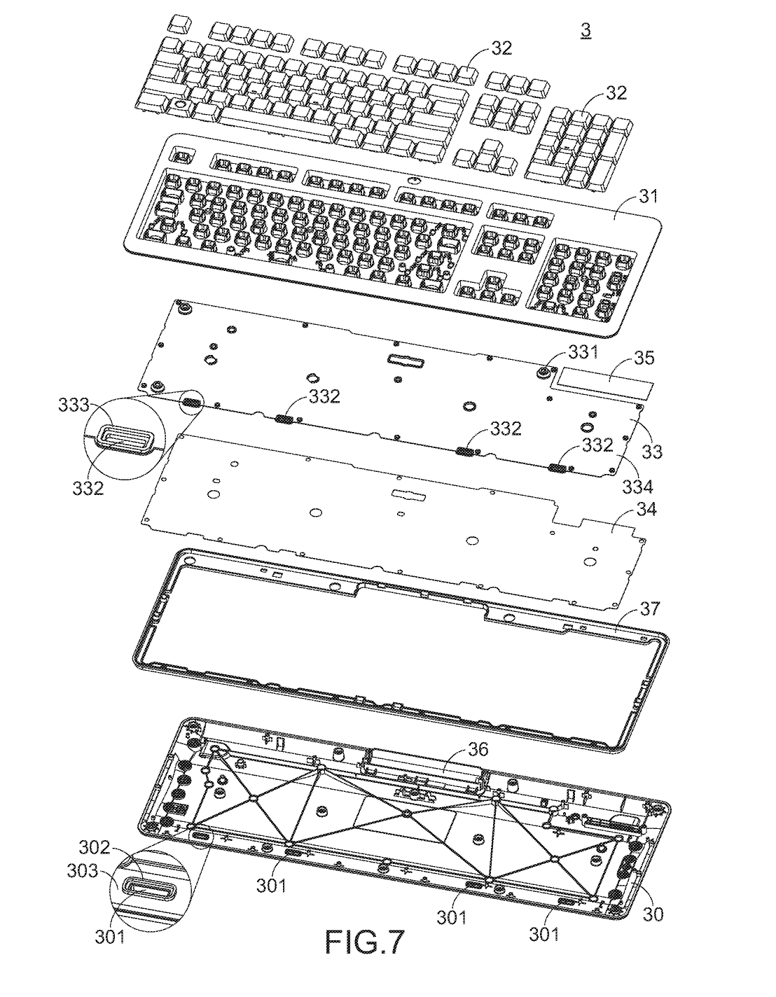

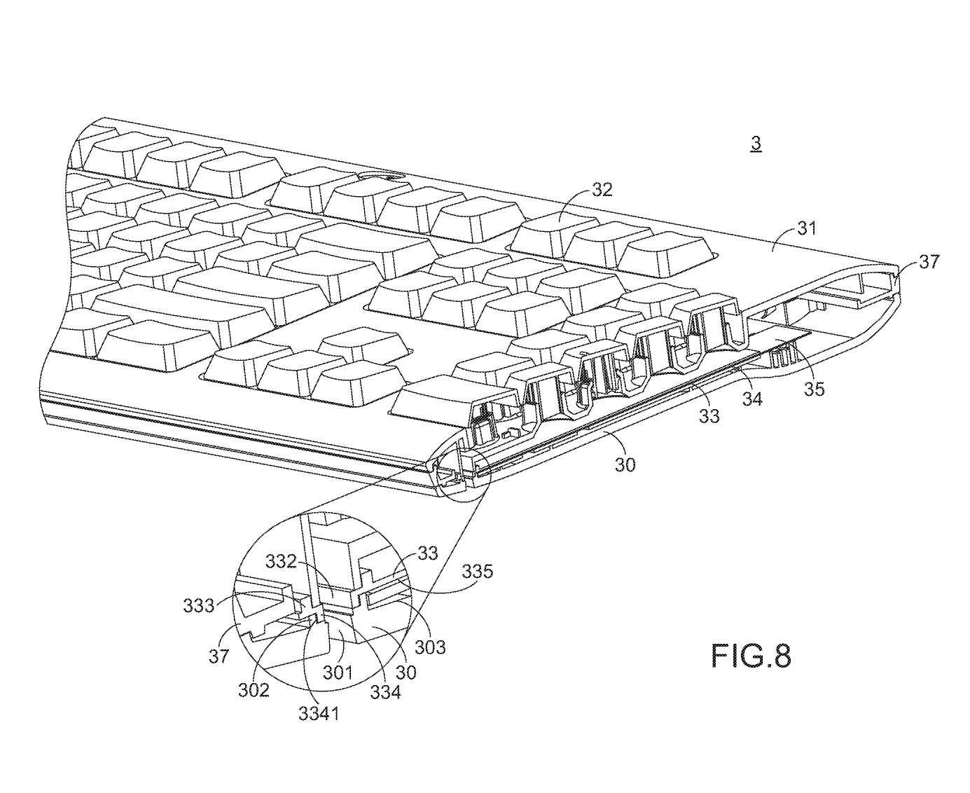

The present invention further provides a second embodiment of the keyboard. FIG. 7 is a schematic exploded view illustrating a keyboard with a water-draining function according to a second embodiment of the present invention. FIG. 8 is a schematic cutaway view illustrating a keyboard with a water-draining function according to the second embodiment of the present invention. As shown in FIGS. 7 and 8, the keyboard 3 comprises a base 30, an upper cover 31, plural keycaps 32, a flexible plate 33, a membrane switch circuit member 34, a main circuit board 35, a battery compartment 36, and a frame 37. Except for the following two items, the other components of the keyboard 3 of this embodiment are substantially identical to those of the keyboard 2 of the first embodiment, and are not redundantly described herein.

Firstly, the base 30 has plural drainage holes 301 and plural base bulges 302 corresponding to respective drainage holes 301. The plural drainage holes 301 are identical to those of the first embodiment, and are not redundantly described herein. The plural base bulges 302 are disposed on a top surface 303 of the base 30. In addition, the plural drainage holes 301 are enclosed by respective base bulges 302. In this embodiment, the plural base bulges 302 are upwardly protruded from the top surface 303 of the base 30. Moreover, the plural base bulges 302 are integrally formed with the base 30. Secondly, the flexible plate 33 comprises plural elastic elements 331 and further comprises plural flexible plate openings 332, plural upper connecting rings 333 and plural lower connecting rings 334. The plural lower connecting rings 334 are aligned with respective flexible plate openings 332. The plural flexible plate openings 332 and the plural upper connecting rings 333 are identical to those of the first embodiment, and are not redundantly described herein. The plural lower connecting rings 334 are disposed on a bottom surface 335 of the flexible plate 33. In addition, the flexible plate openings 332 are enclosed by respective lower connecting rings 334. In this embodiment, the plural lower connecting rings 334 are disposed on a bottom surface 335 of the flexible plate 33. Moreover, the flexible plate openings 332 are enclosed by respective lower connecting rings 334. In this embodiment, the plural lower connecting rings 334 are raised structures that are downwardly protruded from the bottom surface 335 of the flexible plate 33. In addition, the plural lower connecting rings 334 are integrally formed with the flexible plate 33.

In comparison with the first embodiment, the way of connecting the base 30 and the flexible plate 33 is distinguished. In a case that the flexible plate 33 is contacted with the base 30, the outer walls 3341 of the plural lower connecting rings 334 are contacted with respective base bulges 302, so that the plural flexible plate openings 332 are connected with respective drainage holes 301. Moreover, since the outer walls 3341 of the plural lower connecting rings 334 are contacted with respective base bulges 302, the drainage hole 301 of the base 30 and the corresponding flexible plate opening 332 of the flexible plate 33 are connected with each other in a more secure manner.

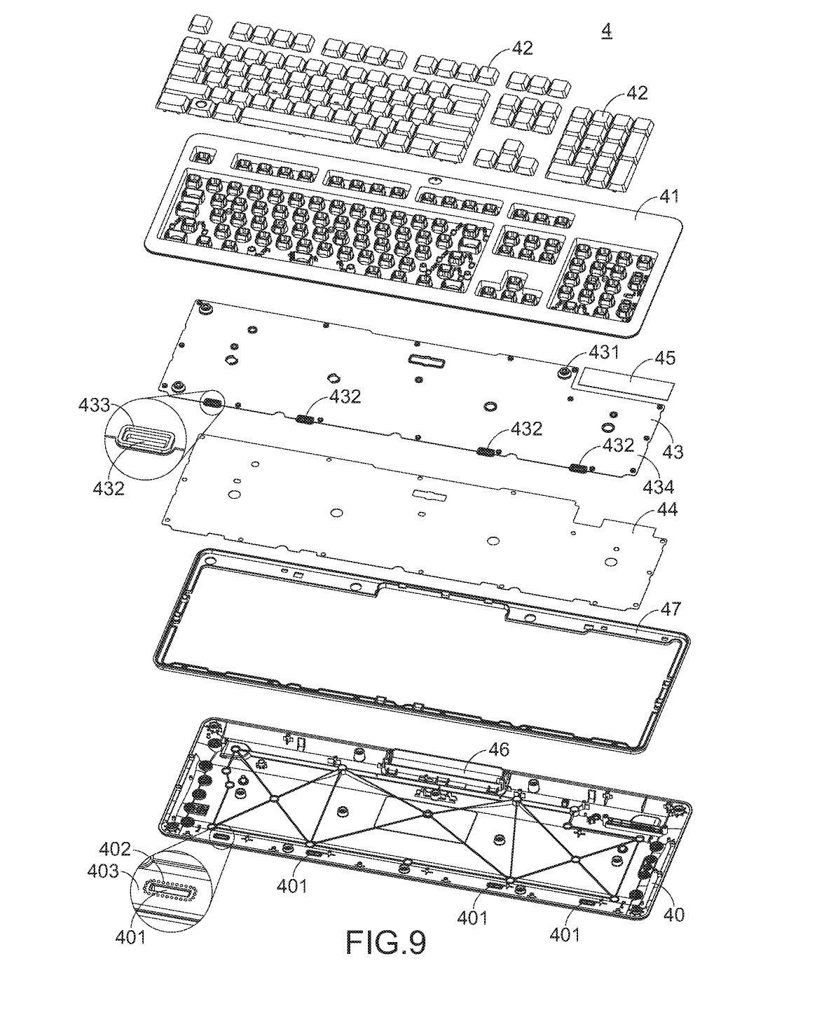

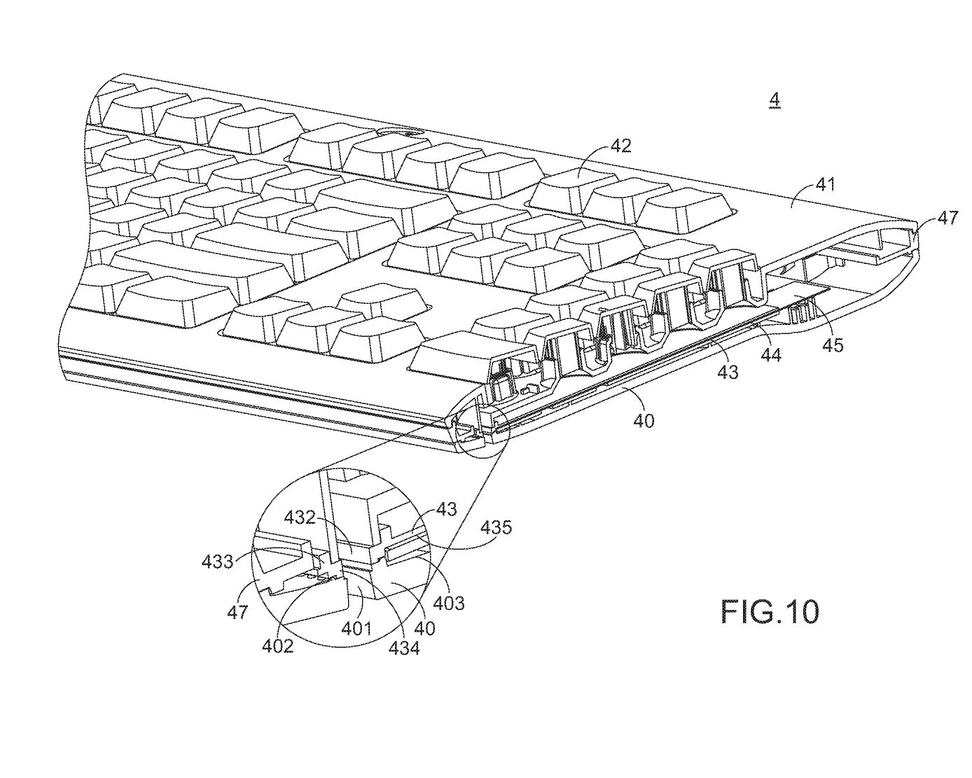

The present invention further provides a third embodiment of the keyboard. FIG. 9 is a schematic exploded view illustrating a keyboard with a water-draining function according to a third embodiment of the present invention. FIG. 10 is a schematic cutaway view illustrating a keyboard with a water-draining function according to the third embodiment of the present invention. As shown in FIGS. 9 and 10, the keyboard 4 comprises a base 40, an upper cover 41, plural keycaps 42, a flexible plate 43, a membrane switch circuit member 44, a main circuit board 45, a battery compartment 46, and a frame 47. Except for the following items, the other components of the keyboard 4 of this embodiment are substantially identical to those of the keyboard 3 of the second embodiment, and are not redundantly described herein.

In comparison with the second embodiment, the base 40 comprises plural drainage holes 401 and plural salient points 402 corresponding to the drainage holes 401. The plural drainage holes 401 of the keyboard 4 are substantially identical to those of the keyboard 2 of the first embodiment, and are not redundantly described herein. Each of the drainage holes 401 is enclosed by plural salient point 402. In this embodiment, the plural salient points 402 are upwardly protruded from the top surface 403 of the base 40. Moreover, the plural salient points 402 are integrally formed with the base 40.

In comparison with the first embodiment, the way of connecting the base 40 and the flexible plate 43 is distinguished. In a case that the flexible plate 43 is contacted with the base 40, the plural lower connecting rings 434 are contacted with the top surface 403 of the base 40 and the plural salient points 402 are contacted with the bottom surface 435 of the flexible plate 435, so that the plural flexible plate openings 432 are connected with respective drainage holes 401.

In this embodiment, since the plural lower connecting rings 434 are contacted with top surface 403 of the base 40 and the plural salient points 402 are contacted with the bottom surface 435 of the flexible plate 435, the plural flexible plate openings 432 are connected with respective drainage holes 401. Consequently, the base 40 and the flexible plate 43 are securely connected with each other.

From the above description, the present invention provides a keyboard with a water-draining function. In the keyboard of the present invention, the flexible plate has an extension part, and plural flexible plate openings are formed in the extension part. After the upper cover, the flexible plate and the base are combined together, a water-draining path is defined. The water-draining path sequentially passes through the upper cover openings, the hollow posts, the flexible plate openings and the drainage holes. If any liquid is splashed into the keyboard, the liquid will be exhausted out of the base through the water-draining path. Since the electronic components within the keyboard of the present invention are not contacted with the liquid, the short-circuited problem is eliminated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A keyboard with a water-draining function, said keyboard comprising:
a base having at least one drainage hole, wherein said at least one drainage hole runs through a top surface and a bottom surface of said base, and a liquid is permitted to flow through said at least one drainage hole;
an upper cover for covering said base, wherein said upper cover has at least one upper cover opening corresponding to said at least one drainage hole, said at least one upper cover opening is located at a bottom part of said upper cover, and said liquid outside said upper cover is permitted to flow into said at least one upper cover opening; and
a flexible plate arranged between said base and said upper cover, wherein said flexible plate is connected with said base and said upper cover, so that said base is connected with said upper cover through said flexible plate, wherein said flexible plate has at least one flexible plate opening corresponding to said at least one drainage hole, wherein said at least one flexible plate opening runs through a top surface and a bottom surface of said flexible plate, wherein said liquid is permitted to flow through said at least one flexible plate opening, and prevented from flowing through a region between said base and said upper cover.

2. The keyboard according to claim 1, wherein said flexible plate further comprises at least one upper connecting ring corresponding to said at least one flexible plate opening, wherein said at least one flexible plate opening is enclosed by said at least one upper connecting ring, and said at least one upper connecting ring is disposed on said top surface of said flexible plate, wherein when said flexible plate is contacted with said upper cover, at least one inner wall of said at least one upper connecting ring is contacted with said upper cover, so that said upper cover is connected with said flexible plate.

3. The keyboard according to claim 2, wherein said upper cover further comprises at least one hollow post corresponding to said upper cover opening, wherein said upper cover opening is enclosed by said at least one hollow post, and said at least one hollow post is contacted with said at least one inner wall of said at least one upper connecting ring, so that said at least one hollow post is connected with said at least one flexible plate opening of said flexible plate.

4. The keyboard according to claim 3, wherein said at least one upper connecting ring is a raised structure protruded from said top surface of said flexible plate, said at least one upper connecting ring is integrally formed with said flexible plate, said at least one hollow post is extended from said bottom part of said upper cover, and said at least one hollow post is integrally formed with said upper cover.

5. The keyboard according to claim 3, wherein after said liquid outside said upper cover flows into said at least one upper cover opening, said liquid sequentially flows through said at least one hollow post, said at least one flexible plate opening and at least one drainage hole, and flows out of said base.

6. The keyboard according to claim 2, wherein said flexible plate further comprises at least one lower connecting ring corresponding to said at least one flexible plate opening, wherein said at least one flexible plate opening is enclosed by said at least one lower connecting ring, and said at least one lower connecting ring is disposed on said bottom surface of said flexible plate, wherein when said flexible plate is contacted with said base, at least one outer wall of said at least one lower connecting ring is contacted with said base, so that said base is connected with said flexible plate.

7. The keyboard according to claim 6, wherein said base further comprises at least one base bulge corresponding to said at least one drainage hole, wherein said at least one base bulge is disposed on said top surface of said base, and said at least one drainage hole is enclosed by said at least one base bulge, wherein said at least one outer wall of said at least one lower connecting ring is contacted with said at least one base bulge, so that said at least one drainage hole of said base is connected with said at least one flexible plate opening of said flexible plate.

8. The keyboard according to claim 7, wherein said at least one lower connecting ring is a raised structure protruded from said bottom surface of said flexible plate, and said at least one lower connecting ring is integrally formed with said flexible plate, wherein said at least one base bulge is protruded from said top surface of said base, and said at least one base bulge is integrally formed with said base.

9. The keyboard according to claim 6, wherein said base further comprises plural salient points, wherein said plural salient points are disposed on said top surface of said base, and said at least one drainage hole is enclosed by said plural salient points, wherein said plural salient points are contacted with said bottom surface of said flexible plate, so that said at least one drainage hole of said base is connected with said at least one flexible plate opening of said flexible plate.

10. The keyboard according to claim 9, wherein said at least one lower connecting ring is a raised structure protruded from said bottom surface of said flexible plate, and said at least one lower connecting ring is integrally formed with said flexible plate, wherein said plural salient points are protruded from said top surface of said base, and said plural salient points are integrally formed with said base.

11. The keyboard according to claim 1, wherein said top surface of said base and said bottom surface of said flexible plate are flat surfaces, and said top surface of said base is contacted with said bottom surface of said flexible plate, so that said at least one drainage hole of said base is connected with said at least one flexible plate opening of said flexible plate.

12. The keyboard according to claim 1, further comprising:
plural keycaps disposed on said upper cover, movable upwardly or downwardly relative to said upper cover, and aligned with plural elastic elements of said flexible plate, wherein when one of said plural keycaps is depressed and moved downwardly relative to said upper cover, said corresponding elastic element is pressed by said keycap;
a membrane switch circuit member arranged between said base and said flexible plate, wherein when said membrane switch circuit member is triggered by said corresponding elastic element of said flexible plate, said membrane switch circuit member issues a corresponding key signal;
a main circuit board disposed on said base and connected with said membrane switch circuit member for receiving, recognizing and outputting said corresponding key signal;
a battery compartment disposed on said base and located beside said membrane switch circuit member for accommodating an electric power storage element, wherein said electric power storage element is connected with said main circuit board for providing electric power to said main circuit board, so that said electric power is transmitted to said membrane switch circuit member through said main circuit board; and
a frame arranged between said upper cover and said base, wherein said membrane switch circuit member, said main circuit board and said battery compartment are enclosed by said frame, so that said membrane switch circuit member, said main circuit board and said battery compartment are not exposed outside.
